(19) United States
(12) Patent Application Publication
(10) Pub. No.: US 2023/0207866 A1
(43) Pub. Date: Jun. 29, 2023

(54) ALL-SOLID-STATE BATTERY COMPRISING SYMMETRICALLY ARRANGED REFERENCE ELECTRODES, DEVICE FOR PRODUCING THE SAME, AND MANUFACTURING METHOD USING THE DEVICE

(71) Applicants: Hyundai Motor Company, Seoul (KR); Kia Corporation, Seoul (KR); Institute for Research & Industry Cooperation Pusan National University, Busan (KR)

(72) Inventors: A Reum Ha, Ulsan (KR); Ju Yeong Seong, Seongnam (KR); In Woo Song, Gwacheon (KR); Hong Seok Min, Yongin (KR); Yong Sub Yoon, Seoul (KR); Yun Sung Kim, Seoul (KR); In Chul Kim, Daejeon (KR); Yong Jun Jang, Seongnam (KR); Sung Woo Noh, Seoul (KR); Heon Cheol Shin, Busan (KR); Gi Hwan Joe, Gumi (KR); Yu Jeong Min, Busan (KR); Ji Ung Jeong, Busan (KR); Seong Hyeok Ha, Changwon (KR)

(21) Appl. No.: 17/962,959

(22) Filed: Oct. 10, 2022

(30) Foreign Application Priority Data
Dec. 24, 2021 (KR) 10-2021-0187215

(51) Int. Cl. H01M 10/0562; H01M 10/058

(52) U.S. Cl. CPC H01M 10/0562; H01M 10/058; H01M 2220/20; H01M 2300/0068

(57) ABSTRACT

Disclosed are an all-solid-state battery including symmetrically arranged reference electrodes, a device for manufacturing the same, and a method of manufacturing using same.

### CROSS-REFERENCE TO RELATED APPLICATION

This application claims under 35 U.S.C. §119(a) the benefit of priority to Korean Patent Application No. 10-2021-0187215, filed on Dec. 24, 2021, the entire contents of which are incorporated herein by reference.

### TECHNICAL FIELD

The present invention relates to an all-solid-state battery including symmetrically arranged reference electrodes, a device for manufacturing the same, and a method of manufacturing using same.

### BACKGROUND

There is no doubt that lithium-ion batteries have the best performance among existing secondary batteries. However, lithium-ion batteries have a risk of ignition and explosion due to the structure thereof. For example, oxygen is contained in the cathode active material and the liquid electrolyte acts as a fuel at high temperatures, thus causing a fire.

When events such as lithium dendrite formation, separator defects, overcharging, or battery cell impact occur, a large current flows, which causes the separator to melt and exposes the anode. Also, the battery temperature increases further, thus causing further decomposition of the cathode material and release of oxygen. Finally, oxygen, heat, and fuel react with one another to cause combustion of the liquid electrolyte.

In the related art, research has been actively underway on next-generation batteries having higher energy density and stability than lithium-ion batteries.

A representative example of next-generation batteries includes an all-solid-state battery. An all-solid-state battery is a battery in which the electrolyte is a solid. Therefore, all materials in the battery become solid.

The all-solid-state battery has excellent stability because it uses a solid electrolyte, which does not evaporate upon temperature change or leak upon application of an external shock. In addition, the all-solid-state battery may have no risk of swelling and can operate normally even in an extreme external environment of high heat and pressure.

In addition, the all-solid-state battery exhibits greatly increased output. Unlike a lithium ion battery using a liquid electrolyte, the all-solid-state battery does not undergo a phenomenon called “desolvation” in which lithium ions are separated from a solvent during charging and discharging. The charging/discharging reaction relates directly to the diffusion reaction of lithium ions in the solid, thus achieving high output.

Also, the all-solid-state battery has another advantage of having a wide operating temperature range. The all-solid-state battery can secure stable performance in a wide temperature range compared to conventional liquid electrolytes. In particular, the all-solid-state battery can be expected to have high ionic conductivity at low temperatures. Electric vehicles have a problem in that, in winter, the performance of the battery deteriorates and mileage decreases. When the era of all-solid-state batteries arrives, anxiety with regard to low-temperature environments will be overcome.

Meanwhile, performance related to the above advantages of all-solid-state batteries can be evaluated in terms of various items such as charge/discharge capacity, charge/discharge characteristics, high-temperature-discharge characteristics, low-temperature discharge characteristics, stability, and lifespan. However, at present there are no regulations setting forth performance standards.

All-solid-state batteries may be discovered to be defective during use or immediately after production. The cause of such defects must be elucidated in order to prevent the occurrence of defective products in subsequently manufactured batteries.

For example, a method of extracting defective products that may be considered at present is to screen out batteries having defective factors such as insufficient capacity or short circuits using X-ray imaging or the like. For this purpose, it will be important to accurately measure and analyze characteristics such as the active material capacity of the electrodes, electrochemical reactivity, and the like.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided is an all-solid-state battery that can stably and reliably measure and analyze the internal resistance of the battery.

As such, the instability and distortion of an electrochemical signal may be minimized by symmetrically disposing reference electrodes inside the all-solid-state battery.

In further preferred aspects, provided is an all-solid-state battery that includes a plurality of symmetrical reference electrodes, which are electrically isolated from one another, and thus can operate in the medium or long term by connecting a fresh reference electrode thereto to replace a deteriorated reference electrode in use.

The objects of the present invention are not limited to those described above. Other objects of the present invention will be clearly understood from the following description, and are able to be implemented by means defined in the claims and combinations thereof.

In one aspect, provided is an all-solid-state battery including a cathode layer, an anode layer, a solid electrolyte layer interposed between the cathode layer and the anode layer. The cathode layer, the anode layer and the solid electrolyte layer may be stacked in a thickness direction. Further, at least two pairs of reference electrode may be inserted on a side surface of the solid electrolyte layer in the direction perpendicular to the thickness direction of the cathode layer, the anode layer, and the solid electrolyte layer. Particularly, the reference electrode pairs may be symmetrically arranged with respect to a center point of the solid electrolyte layer.

Each of the reference electrodes may include: (i) an electric wire including one or more selected from the group consisting of tungsten (W), aluminum (Al), nickel (Ni), and stainless steel (SUS), and (ii) a coating including one or more noble metals selected from the group consisting of gold (Au), silver (Ag), and platinum (Pt).

The at least two pairs of reference electrodes may be inserted at right angles to each other.

A number of the reference electrodes may be represented as 2n and n is an integer of 1 or greater.

In another aspect, provided is a device for manufacturing an all-solid-state battery, which may include: a mold comprising a first hole having the same shape and width as those of the all-solid-state battery and penetrating therethrough in a vertical direction, and a plurality of second holes configured to communicate with the first hole at a side surface thereof, a first presser comprising a protruding member corresponding to the first hole, the first presser fitted into a top of the mold and configured to press a raw material of the all-solid-state battery filling the first hole in an upper part, a second presser comprising a protruding member corresponding to the first hole, the second presser fitted into a bottom of the mold and pressing a raw material of the all-solid-state battery filling the first hole in a lower part, and at least two pairs of second holes symmetrically arranged with respect to a center point of the first hole.

The mold may further include an insulating member on a surface of the first hole.

The mold may further include an insulating member on a surface of the second hole.

The second holes may communicate with the first hole such that one pair of second holes form a right angle with another pair of second holes.

The first presser and the second presser may include a conductive material.

In another aspect, provided is a method of manufacturing an all-solid-state battery, which may include coupling the second presser to the bottom of the mold so as to fit the protruding member of the second presser into the first hole, injecting a first solid electrolyte powder onto the protruding member of the second presser, coupling the first presser to the top of the mold so as to fit the protruding member of the first presser into the first hole and pressing the first solid electrolyte powder to form a first solid electrolyte layer, detaching the first presser therefrom and inserting a plurality of reference electrodes through the second hole to load the reference electrodes on the first solid electrolyte layer, injecting a second solid electrolyte powder onto the reference electrodes, coupling the first presser to the top of the mold so as to fit the protruding member of the first presser into the first hole and pressing the second solid electrolyte powder to form a second solid electrolyte layer, detaching the first presser therefrom and loading an anode layer on the second solid electrolyte layer, detaching the second presser therefrom and loading a cathode layer on the first solid electrolyte layer, and pressing a structure in the first hole using the mold, the first presser, and the second presser together.

The first solid electrolyte powder and the second solid electrolyte powder may include a sulfide-based solid electrolyte.

Each reference electrode may include (i) an electric wire including one or more selected from the group consisting of tungsten (W), aluminum (Al), nickel (Ni), and stainless steel (SUS), and (ii) a coating one or more noble metals selected from the group consisting of gold (Au), silver (Ag), and platinum (Pt).

The method may further include inserting a stopper into the second hole so as not to expose the structure in the first hole to the outside through the second hole.

In another aspect, the present invention provides a method of manufacturing an all-solid-state battery, the method including coupling the second presser to the bottom of the mold so as to fit the protruding member of the second presser into the first hole, loading an anode layer onto the protruding member of the second presser, injecting a first solid electrolyte powder onto the anode layer, coupling the first presser to the top of the mold so as to fit the protruding member of the first presser into the first hole and pressing the first solid electrolyte powder to form a first solid electrolyte layer, detaching the first presser therefrom and inserting a plurality of reference electrodes through the second hole to load the reference electrodes on the first solid electrolyte layer, injecting a second solid electrolyte powder onto the reference electrodes, coupling the first presser to the top of the mold so as to fit the protruding member of the first presser into the first hole and pressing the second solid electrolyte powder to form a second solid electrolyte layer, detaching the first presser therefrom and loading an anode layer on the second solid electrolyte layer, and pressing a structure in the first hole using the mold, the first presser, and the second presser together.

In further aspects, provided herein is a vehicle including the all-solid-state battery of claim as described herein.

Other aspects of the present the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows a cross-sectional view illustrating an exemplary all-solid-state battery according to an exemplary embodiment of the present invention;

FIG. 2 shows a plan view illustrating an exemplary all-solid-state battery according to an exemplary embodiment of the present invention;

FIG. 3 shows an exemplary device for manufacturing an all-solid-state battery according to an exemplary embodiment of the present invention;

FIG. 4 shows the manufacturing device of FIG. 3 and an all-solid-state battery manufactured using the same;

FIGS. 5A to 5F show exemplary methods of manufacturing an exemplary all-solid-state battery according to an exemplary embodiment of the present invention;

FIG. 6A shows the state in which a reference electrode of the all-solid-state battery according to Example is inserted;

FIG. 6B shows the state in which the reference electrode of the all-solid-state battery according to Comparative Example is inserted;

FIG. 7A shows the electrochemical impedance of cathodes for the all-solid-state batteries according to Example and Comparative Example;

FIG. 7B shows the electrochemical impedance of anodes for the all-solid-state batteries according to Example and Comparative Example;

FIG. 8A shows potential signals of the cathode and anode of the all-solid-state battery according to Example; and

FIG. 8B shows potential signals of the cathode and anode of the all-solid-state battery according to Comparative Example.

### DETAILED DESCRIPTION

The objects described above, as well as other objects, features and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to include the plural meaning as well, unless the context clearly indicates otherwise.

It will be further understood that the terms “comprises” and/or “has”, when used in this specification, specify the presence of stated features, integers, steps, operations, elements, components, or combinations thereof, but do not preclude the presence or addition of one or more other features, integers, steps, operations, elements, components, or combinations thereof. In addition, it will be understood that, when an element such as a layer, film, region, or substrate is referred to as being “on” another element, it can be directly on the other element, or an intervening element may also be present. It will also be understood that when an element such as a layer, film, region, or substrate is referred to as being “under” another element, it can be directly under the other element, or an intervening element may also be present.

Unless the context clearly indicates otherwise, all numbers, figures, and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A reference electrode is defined as an electrode having a stable electrochemical potential acting as a reference point for measuring the potential of at least one electrode in an electrochemical battery.

In the related art, a method for manufacturing an all-solid-state battery including inserting a reference electrode between solid electrolyte layers has been reported. In particular, a conductive paste may be used to bond the solid electrolyte to the reference electrode.

For example, a conductive paste may be applied on a solid electrolyte and pressing a reference electrode on the conductive paste. Therefore, the interface between the solid electrolyte and the reference electrode may be distorted, or the interface contact may be poor, making it difficult for the reference electrode to reliably detect a signal from a cathode or anode.

In addition, reliable solid electrolyte resistance may not be obtained because the conductive paste alters the solid electrolyte resistance between the reference electrode and the cathode.

Meanwhile, the conductive paste may cause a problem of poor contact between the solid electrolytes disposed on the upper and lower surfaces of the reference electrode, so the movement of lithium ions in the solid electrolyte layer may be impeded. As a result, the signal obtained through the reference electrode is acquired from an all-solid-state battery in an abnormal operating state, so it is impossible to accurately determine the state of the battery.

In contrast, the present invention has been made in an effort to solve the above-described problems associated with the prior art and is characterized in that a powdered solid electrolyte and a reference electrode are pressed together, without using a conductive paste, so the interface between the two components can be evenly formed, and lithium ions can move smoothly in the solid electrolyte layer. In addition, the pressure applied to the battery may be prevented from becoming non-uniform during pressing to manufacture an all-solid-state battery using at least two pairs of symmetrically arranged reference electrodes. Accordingly, it is possible to stably acquire an electrochemical signal from the inside of the all-solid-state battery.

Further, since a plurality of reference electrodes, which are electrically isolated from one another, is used, even if one reference electrode is contaminated during operation, electrochemical signals can be obtained from the other reference electrode, and thus stable operation in the medium or long term is possible.

Also provided is a manufacturing apparatus (e.g., device) that is provided with an insulating member inside a mold, so the all-solid-state battery can be used as a battery by itself without separating the all-solid-state battery from the mold.

In addition, the present invention does not involve application of other material such as a conductive paste between the reference electrode and the solid electrolyte, so the signal of the reference electrode is not distorted by the other material and thus the reliability of the result is high.

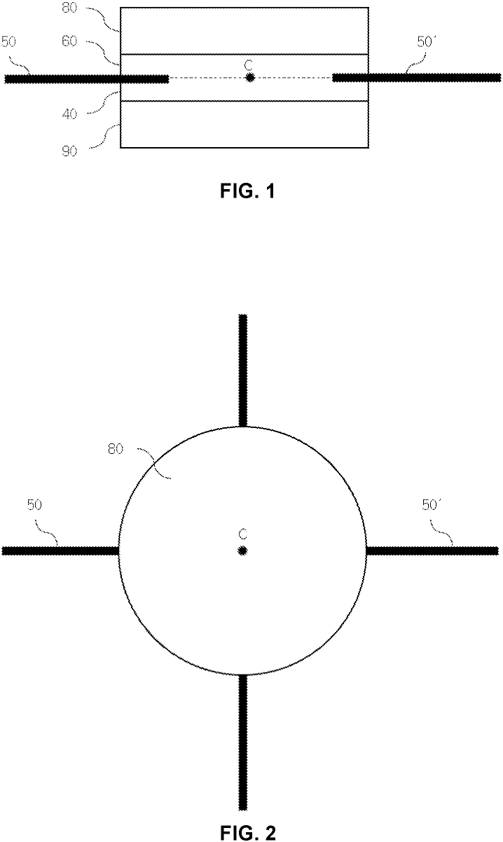

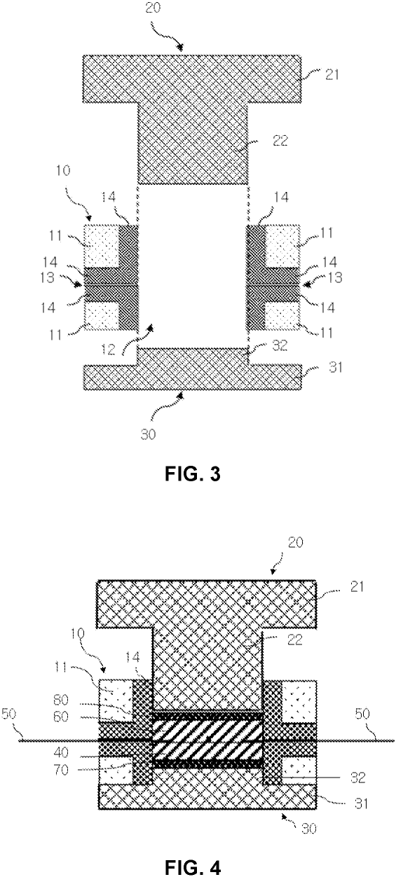

FIG. 1 shows a cross-sectional view illustrating an exemplary all-solid-state battery according to an exemplary embodiment of the present invention. FIG. 2 shows a plan view illustrating an exemplary all-solid-state battery according to an exemplary embodiment of the present invention. theretofore example, the all-solid-state battery may include a cathode layer 90, an anode layer 80, and a solid electrolyte layer interposed between the cathode layer 90 and the anode layer 80. The solid electrolyte layer may include a first solid electrolyte layer 40 on the cathode layer 90 and a second solid electrolyte layer 60 on the anode layer 80.

The all-solid-state battery may include at least two pairs of reference electrodes 50 and 50′ that are inserted from the side into the interface between the first solid electrolyte layer 40 and the second solid electrolyte layer 60 and are symmetrically arranged with respect to the center point C of the solid electrolyte layer. Here, the reference electrode pairs 50 and 50′ may be inserted from the side of the solid electrolyte layer in a direction perpendicular to a thickness direction, i.e., a stacking direction of the cathode layer, the anode layer, and the solid electrolyte layer.

Preferably, the all-solid-state battery may include two pairs of the reference electrodes 50 and 50′, and the two pairs of reference electrodes may be inserted at right angles to each other.

The all-solid-state battery may include 2n (wherein n is an integer of 1 or more, or is an integer of 2 or more) reference electrodes constituting the reference electrode pair 50 and 50′. The number of the reference electrodes may be appropriately adjusted in consideration of the area and volume of the all-solid-state battery, and the upper limit thereof is not particularly limited, but may be 8, 10, or 12.

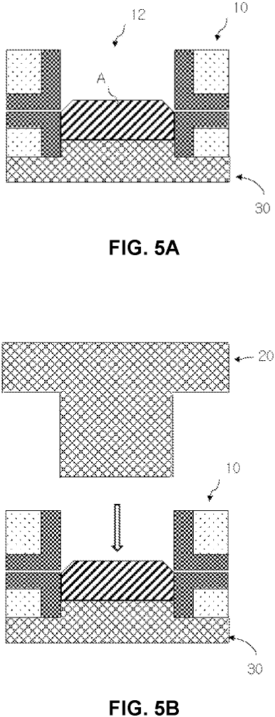

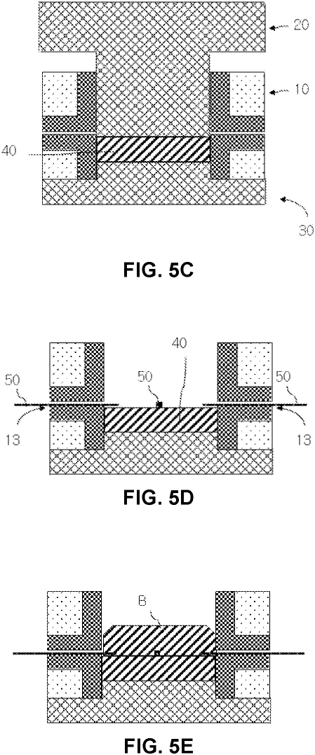

FIG. 3 shows an exemplary device for manufacturing an all-solid-state battery according to an exemplary embodiment of the present invention. FIG. 4 shows the manufacturing device of FIG. 3 and an all-solid-state battery manufactured using the same.

The all-solid-state battery according to an exemplary embodiment of the present invention may be operated separately from the manufacturing device shown in FIGS. 1 and 2, or the all-solid-state battery may be operated in the state shown in FIG. 4.

As shown in FIGS. 3 and 4, the manufacturing device includes a mold 10 configured to provide a molding space for an all-solid-state battery, a first presser 20 coupled to an upper surface of the mold 10, and a second presser 30 coupled to a lower surface of the mold 10. For reference, in this specification, “upper” and “lower” are based on the illustrated state, and the present invention is not limited thereto. Particularly, in an embodiment, it should be interpreted that if the first presser 20 and the second presser 30 are coupled to the mold 10 in opposite directions with respect to the mold 10, this configuration falls within the scope of the present invention, without being limited to the terms “upper” and “lower”.

The mold 10 may include a body member 11, a hole 12 that has the same shape and width as that of the all-solid-state battery and penetrates through the body member 11 in a vertical direction, and a plurality of second holes 13 formed to communicate with the first hole 12 at a side surface thereof.

The mold 10 may include at least two pairs of second holes 13 symmetrically arranged with respect to a center point of the first hole 12.

The mold 10 may further include an insulating member 14 on the surface of the first hole 12 and/or the surface of the second hole 13.

The first presser 20 includes a first substrate 21 and a first protruding member 22 that protrudes from the first substrate 21 and has a shape corresponding to the first hole 12.

The first substrate 21 is configured to function as a kind of stopper when the first presser 20 is coupled to the mold 10. The first substrate 21 may be a plate-shaped structure which is wider than the area of the first hole 12.

The first protruding member 22 is inserted into the first hole 12 to press the raw material inside the mold 10.

As shown in FIG. 4, the first presser 20 finally comes into contact with the anode layer 80 through the first protruding member 22. The first substrate 21 and the first protruding member 22 may be formed of a conductive material, so the first presser 20 may serve as a current collector for the anode layer 80.

The second presser 30 includes a second substrate 31 and a second protruding member 32 that protrudes from the second substrate 31 and has a shape corresponding to the first hole 12.

The second substrate 31 may function as a kind of stopper when the second presser 30 is coupled to the mold 10. The second substrate 31 may be a plate-shaped structure which is wider than the area of the first hole 12.

The second protruding member 32 is inserted into the first hole 12 to press the raw material inside the mold 10.

As shown in FIG. 4, the second presser 30 finally comes into contact with the cathode layer 90 through the second protruding member 32. The second substrate 31 and the second protruding member 32 may include a conductive material, so the second presser 30 can serve as a current collector for the cathode layer 90.

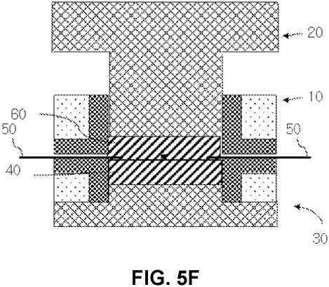

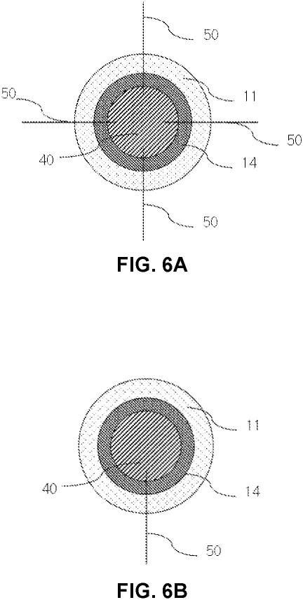

FIGS. 5A to 5F and 6A show an exemplary method of manufacturing an all-solid-state battery according to an exemplary embodiment of the present invention.

As shown in FIG. 5A, the manufacturing method begins from coupling the second presser 30 to the bottom of the mold 10 so as to fit the protruding member 32 of the second presser 30 into the first hole 12. Then, a first solid electrolyte powder A is injected into the protruding member 32 of the second presser 30.

In the present invention, rather than inserting the already completed solid electrolyte layer into the mold 10, the solid electrolyte powder may be injected and pressed along with the reference electrode 50 to be described later to form the solid electrolyte layers 40 and 60. Accordingly, the interface between the solid electrolyte layers 40 and 60 and the reference electrode 50 is evenly formed.

The first solid electrolyte powder A may include a sulfide-based solid electrolyte. The sulfide-based solid electrolyte may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers, and Z is at least one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂ and the like.

As shown in FIG. 5B, the first presser 20 may be coupled to the top of the mold 10 so as to fit the protruding member 22 of the first presser 20 into the first hole 12, and then the first solid electrolyte powder A may be pressed. As a result, the first solid electrolyte layer 40 can be obtained as shown in FIG. 5C.

Then, as shown in FIG. 5D, the first presser 20 may be detached therefrom and a plurality of reference electrodes 50 is inserted through the second hole 13 and is loaded on the first solid electrolyte layer 40.

At this time, as shown in FIG. 6A, the reference electrodes 50 may be inserted symmetrically in four directions.

The reference electrode 50 may be an electric wire including one or more selected from the group consisting of tungsten (W), aluminum (Al), nickel (Ni), stainless steel (SUS), which may be coated with at least one noble metal selected from the group consisting of gold (Au), silver (Ag), and platinum (Pt).

The material for the electric wire is not particularly limited, and any material having low reactivity with a solid electrolyte, such as tungsten (W), or alternatively, aluminum (Al), nickel (Ni), stainless steel (SUS), etc., having strength comparable to tungsten (W), can also be used.

The reference electrode 50 may include an electric wire and thus does not physically isolate the first solid electrolyte layer 40 from the second solid electrolyte layer 60 in the manner of a separator.

After the reference electrode 50 is loaded, the second solid electrolyte powder B may be injected into the reference electrode 50, as shown in FIG. 5E. The second solid electrolyte powder B may suitably include a sulfide-based solid electrolyte. The sulfide-based solid electrolyte may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₂—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is any one of Ge, Zn, and Ga), Li₂S—GeS₂, Li₂S—SiS₂—Li₃PO₄, Li₂S—SiS₂—LiₓMO_{y} (wherein x and y are positive numbers and M is any one of P, Si, Ge, B, Al, Ga, and In), Li₁₀GeP₂S₁₂, and the like. The second solid electrolyte powder B may be the same as or different from the first solid electrolyte powder A.

Then, as shown in FIG. 5F, the first presser 20 may be coupled to the top of the mold 10 so as to fit the protruding member 22 of the first presser 20 into the first hole 12. Thus, the second solid electrolyte layer 60 may be formed by pressing the second solid electrolyte powder B.

Through the above process, a structure in which the reference electrode 50 is inserted between the first solid electrolyte layer 40 and the second solid electrolyte layer 60 may be obtained. In the process of obtaining the structure, the first presser 20 and the second presser 30 may be only at a magnitude of pressure such that the first solid electrolyte powder A and the second solid electrolyte powder B can maintain the shape of a series of layers. The all-solid-state battery may be pressurized not at a high pressure, as in the case of manufacturing an all-solid-state battery using a dry process, but at a low pressure for planarization.

Then, the first presser 20 may be detached, and an anode layer 80 may be loaded on the second solid electrolyte layer 60. In addition, the second presser 30 may be detached therefrom, and a cathode layer 90 may be loaded on the first solid electrolyte layer 40.

A manufacturing method in which the first solid electrolyte layer 40, the reference electrode 50, and the second solid electrolyte layer 60 may be first formed, after which the cathode layer 90 and the anode layer 80 are added has been described. However, the manufacturing method of the present invention is not limited thereto, and as will be described later, the cathode layer 90 may be first added, the first solid electrolyte layer 40, the reference electrode 50 and the second solid electrolyte layer 60 may then be formed on the cathode layer 90, and then the anode layer 80 is added thereto to obtain the same all-solid-state battery.

The manufacturing method according to an exemplary embodiment of the present invention may include coupling the second presser 30 to the bottom of the mold 10 so as to fit the protruding member 32 of the second presser 30 into the first hole 12, loading the cathode layer 90 onto the protruding member 32 of the second presser 30, injecting the first solid electrolyte powder onto the cathode layer 90, coupling the first presser 20 to the top of the mold 10 so as to fit the protruding member 22 of the first presser 20 into the first hole 12 and pressing the first solid electrolyte powder A to form a first solid electrolyte layer 40, detaching the first presser 20 therefrom and inserting the reference electrode 50 through the second hole 13 to load the reference electrode 50 on the first solid electrolyte layer 40, injecting the second solid electrolyte powder B onto the reference electrode 50, coupling the first presser 20 to the top of the mold 10 so as to fit the protruding member 22 of the first presser 20 into the first hole 12 and pressing the second solid electrolyte powder B to form a second solid electrolyte layer 60, detaching the first presser 20 therefrom and loading an anode layer 80 onto the second solid electrolyte layer 60, and pressing the structure in the first hole 12 using the mold 10, the first presser 20, and the second presser 30 together.

### EXAMPLE

Hereinafter, the present invention will be described in more detail with reference to specific examples. However, the following examples are provided only for better understanding of the present invention, and thus should not be construed as limiting the scope of the present invention.

### Example

As shown in FIG. 6A, an all-solid-state battery including symmetrically inserted reference electrodes was prepared. As the reference electrodes, wires having a diameter of 100 µm and made of aluminum were used, and a sulfide-based solid electrolyte powder was used. The reference electrodes were disposed symmetrically with respect to a reference point and were inserted to a depth of 6 mm into the solid electrolyte layer.

### Comparative Example

An all-solid-state battery including reference electrodes inserted asymmetrically as shown in FIG. 6B was manufactured using the same material as in Example above. In order to asymmetrically insert the reference electrodes, the reference electrodes were inserted only 6 mm deep into the electrolyte without crossing the center.

### Experimental Example - Measurement and Analysis of Electrochemical Impedance Signal of Each Electrode

Electrochemical impedance signals of the cathode and the anode were measured and analyzed in all-solid-state batteries according to Examples and Comparative Examples. The measurement of Comparative Example was performed using the inserted reference electrode, since the all-solid-state battery manufactured according to Comparative Example had only one reference electrode, whereas the measurement of Example was performed using one randomly selected from the inserted reference electrodes, since the all-solid-state battery manufactured according to Example had a plurality of reference electrodes.

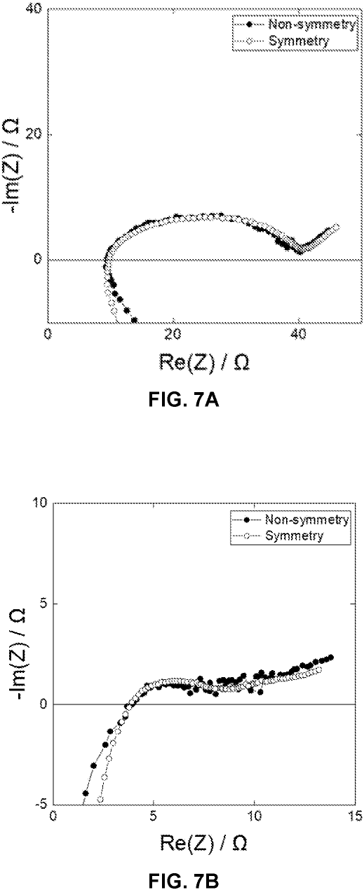

FIG. 7A shows the electrochemical impedance of cathodes for the all-solid-state batteries according to Examples and Comparative Examples. FIG. 7B shows the electrochemical impedance of anodes for the all-solid-state batteries according to Examples and Comparative Examples. In FIGS. 7A and 7B, Comparative Example is referred to as an “asymmetric cell”, and it can be seen that the impedance signal is very unstable due to the asymmetric arrangement. On the other hand, in Example referred to as a “symmetric cell”, it can be seen that a very stable impedance signal is measured, as internal symmetry is secured.

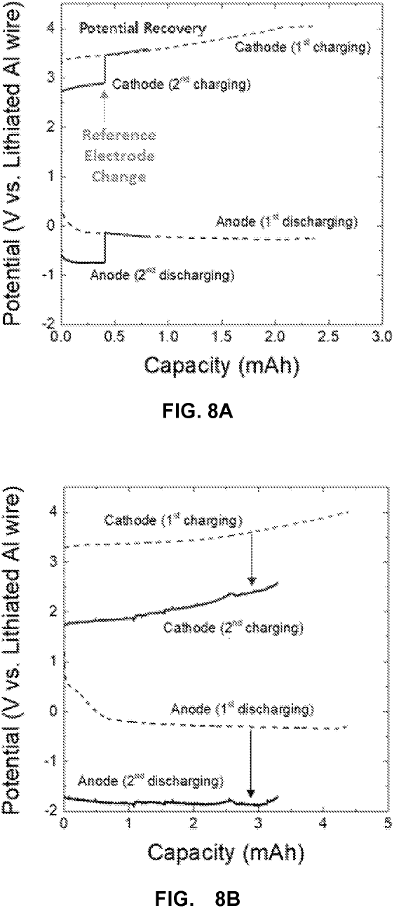

FIG. 8A shows potential signals of the cathode and anode of the all-solid-state battery according to Example. When measuring the potential signal of the all-solid-state battery according to Example, the reference electrode to be measured at a specific time point was changed. FIG. 8B shows potential signals of the cathode and anode of the all-solid-state battery according to Comparative Example.

As shown in FIGS. 8A and 8B, in Comparative Example, the potential was changed due to contamination of the reference electrode, whereas in Example, when one reference electrode is contaminated, the signal was stably acquired by changing the measurement target to another reference electrode.

According to various exemplary embodiments of the present invention, an all-solid-state battery may be manufactured by simultaneously pressing a powder-type solid electrolyte and the reference electrode, so contact between the reference electrode and the solid electrolyte is very excellent compared to the prior art. Therefore, a stable electrochemical signal using the reference electrode may be obtained.

According to various exemplary embodiments of the present invention, the internal resistance of a battery with high stability and reliability may be measured and analyzed.

According to various exemplary embodiments of the present invention, the solid electrolyte may be formed very uniformly, so the all-solid-state battery may operate smoothly during analysis using the reference electrode inserted therein.

According to various exemplary embodiments of the present invention, other materials such as conductive paste may not be applied between the reference electrode and the solid electrolyte, so the signal of the reference electrode may not be distorted by other materials, and the reliability of the result may be improved.

According to various exemplary embodiments of the present invention, the inner wall of the mold and the periphery of the reference electrode, which may cause a short circuit, may be isolated, so the manufactured all-solid-state battery may be used without separating the same from the mold. Accordingly, there is no need to connect the current collector after the all-solid-state battery is separated from the mold, so damage to the battery that may occur during the separation process can be avoided.

The effects of the present invention are not limited to those mentioned above. It should be understood that the effects of the present invention include all effects that can be inferred from the description of the present invention.

The present invention has been described in detail with reference to exemplary embodiments thereof. However, it will be appreciated by those skilled in the art that changes may be made in these examples without departing from the principles and spirit of the present invention, the scope of which is defined in the appended claims and their equivalents.

What is claimed is:

1. An all-solid-state battery comprising:
a cathode layer;
an anode layer;
a solid electrolyte layer interposed between the cathode layer and the anode layer, wherein the cathode layer, the anode layer and the solid electrolyte layer are stacked in a thickness direction; and
at least two pairs of reference electrodes inserted laterally into the solid electrolyte layer in a direction perpendicular to the thickness direction, the at least two pairs of the reference electrodes symmetrically arranged with respect to a center point of the solid electrolyte layer.

2. The all-solid-state battery according to claim 1, wherein each of the reference electrodes comprises (i) an electric wire comprising one or more selected from the group consisting of tungsten (W), aluminum (Al), nickel (Ni), and stainless steel (SUS), and a (ii) a coating comprising one or more selected from the group consisting of gold (Au), silver (Ag), and platinum (Pt).

3. The all-solid-state battery according to claim 1, wherein the at least two pairs of reference electrodes are inserted at right angles to each other.

4. The all-solid-state battery according to claim 1, wherein a number of the reference electrodes is represented by 2n, wherein n is an integer of 1 or greater.

5. A device for manufacturing an all-solid-state battery, the device comprising:
a mold comprising a first hole having the same shape and width as those of the all-solid-state battery and penetrating therethrough in a vertical direction, and a plurality of second holes configured to communicate with the first hole at a side surface thereof;
a first presser comprising a protruding member corresponding to the first hole, the first presser fitted into a top of the mold and configured to press a raw material of the all-solid-state battery filling the first hole in an upper part;
a second presser comprising a protruding member corresponding to the first hole, the second presser fitted into a bottom of the mold and pressing a raw material of the all-solid-state battery filling the first hole in a lower part; and
at least two pairs of second holes symmetrically arranged with respect to a center point of the first hole.

6. The device according to claim 5, wherein the mold further comprises an insulating member on a surface of the first hole.

7. The device according to claim 5, wherein the mold further comprises an insulating member on a surface of the second hole.

8. The device according to claim 5, wherein one pair of second holes form a right angle with another pair of second holes.

9. The device according to claim 5, wherein the first presser and the second presser comprise a conductive material.

10. A method of manufacturing an all-solid-state battery comprising a reference electrode using a device according to claim 5, comprising:
coupling the second presser to the bottom of the mold so as to fit the protruding member of the second presser into the first hole;
injecting a first solid electrolyte powder onto the protruding member of the second presser;
coupling the first presser to the top of the mold so as to fit the protruding member of the first presser into the first hole and pressing the first solid electrolyte powder to form a first solid electrolyte layer;
detaching the first presser therefrom and inserting a plurality of reference electrodes through the second hole to load the reference electrodes on the first solid electrolyte layer;
injecting a second solid electrolyte powder onto the reference electrodes;
coupling the first presser to the top of the mold so as to fit the protruding member of the first presser into the first hole and pressing the second solid electrolyte powder to form a second solid electrolyte layer;
detaching the first presser therefrom and loading an anode layer on the second solid electrolyte layer;
detaching the second presser therefrom and loading a cathode layer on the first solid electrolyte layer; and
pressing a structure in the first hole using the mold, the first presser, and the second presser together.

11. The method according to claim 10, wherein the first solid electrolyte powder and the second solid electrolyte powder comprise a sulfide-based solid electrolyte.

12. The method according to claim 10, wherein the reference electrode comprises an electric wire containing one or more selected from the group consisting of tungsten (W), aluminum (Al), nickel (Ni), and stainless steel (SUS), and a coating comprising one more selected from the group consisting of gold (Au), silver (Ag), and platinum (Pt).

13. The method according to claim 10, further comprising inserting a stopper into the second hole so as not to expose the structure in the first hole to the outside through the second hole.

14. A method of manufacturing an all-solid-state battery comprising a reference electrode using a device according to claim 5, comprising:
coupling the second presser to the bottom of the mold so as to fit the protruding member of the second presser into the first hole;
loading an anode layer onto the protruding member of the second presser;
injecting a first solid electrolyte powder onto the anode layer;
coupling the first presser to the top of the mold so as to fit the protruding member of the first presser into the first hole and pressing the first solid electrolyte powder to form a first solid electrolyte layer;
detaching the first presser therefrom and inserting a plurality of reference electrodes through the second hole to load the reference electrodes on the first solid electrolyte layer;
injecting a second solid electrolyte powder onto the reference electrodes;
coupling the first presser to the top of the mold so as to fit the protruding member of the first presser into the first hole and pressing the second solid electrolyte powder to form a second solid electrolyte layer;
detaching the first presser therefrom and loading an anode layer on the second solid electrolyte layer; and
pressing a structure in the first hole using the mold, the first presser, and the second presser together.

15. The method according to claim 14, wherein the first solid electrolyte powder and the second solid electrolyte powder comprise a sulfide-based solid electrolyte.

16. The method according to claim 14, wherein the reference electrode comprises an electric wire comprising one or more selected from the group consisting of tungsten (W), aluminum (Al), nickel (Ni), and stainless steel (SUS), and a coating comprising one or more noble metals selected from the group consisting of gold (Au), silver (Ag), and platinum (Pt).

17. The method according to claim 14, further comprising inserting a stopper into the second hole so as not to expose the structure in the first hole to the outside through the second hole.

18. A vehicle comprising an all-solid-state battery according to claim 1.
